(19) United States
(12) Patent Application Publication
(10) Pub. No.: US 2020/0175355 A1
(43) Pub. Date: Jun. 4, 2020

(54) NEURAL NETWORK ACCELERATOR WITH SYSTOLIC ARRAY STRUCTURE

(71) Applicant: ELECTRONICS AND TELECOMMUNICATIONS RESEARCH INSTITUTE, Daejeon (KR)

(72) Inventors: Jaehoon CHUNG, Daejeon (KR); Young-Su KWON, Daejeon (KR); Chun-Gi LYUH, Daejeon (KR); Chan KIM, Daejeon (KR); Hyun Mi KIM, Daejeon (KR); Jeongmin YANG, Busan (KR); Yong Cheol Peter CHO, Daejeon (KR)

(21) Appl. No.: 16/677,835

(22) Filed: Nov. 8, 2019

(30) Foreign Application Priority Data
Nov. 30, 2018 (KR) 10-2018-0153140
Apr. 9, 2019 (KR) 10-2019-0041651

(51) Int. Cl. G06N 3/063; G06N 3/04; G06F 15/80

(52) U.S. Cl. CPC G06N 3/063; G06F 15/8046; G06N 3/04

(57) ABSTRACT

A neural network accelerator in which processing elements are configured in a systolic array structure includes a memory to store a plurality of feature data including first and second feature data and a plurality of kernel data including first and second kernel data, a first processing element to perform an operation based on the first feature data and the first kernel data and output the first feature data, a selection circuit to select one of the first feature data and the second feature data, based on a control signal, and output the selected feature data, a second processing element to perform an operation based on the selected feature data and one of the first and the second kernel data, and a controller to generate the control signal, based on a neural network characteristic associated with the plurality of feature data and kernel data.

### CROSS-REFERENCE TO RELATED APPLICATIONS

This U.S. non-provisional patent application claims priority under 35 U.S.C. § 119 of Korean Patent Application Nos. 10-2018-0153140, filed on Nov. 30, 2018, and 10-2019-0041651, filed on Apr. 9, 2019, respectively, the entire contents of which are hereby incorporated by reference.

### BACKGROUND

Example embodiments of the inventive concepts relate to a semiconductor device, and more particularly, relate to a neural network accelerator in which processing elements are configured in a systolic array structure.

Recently, as neural network-based data processing techniques are developed, a computing device having a high computing capability is required. In neural network-based operations, since data are processed according to a preset pattern of algorithms, a graphic processing unit (GPU) that has high performance for simple parallel operations are mainly used. However, the GPU is an optimized architecture for processing graphics operations, which consumes a lot of power, making it difficult to use in applications where power supply is limited.

To solve the problems of conventional computing devices, a neural network accelerator having a systolic array structure that is optimized for matrix computation and input data reuse, has been used. The neural network accelerator of the systolic array structure includes processing elements (PE) arranged in a form of a two-dimensional array. The processing elements that are arranged in the form of the two-dimensional array may perform an operation based on received input data, and sequentially transfer the received input data to adjacent processing elements.

In the neural network accelerator with this general systolic array structure, since a direction of a data transfer is fixed, a utilization rate of the neural network accelerator may decrease, depending on neural network characteristics. That is, depending on the neural network characteristics, only some processing elements may be used to perform operations.

### SUMMARY

Embodiments of the inventive concepts provide a neural network accelerator for improving a utilization rate of a neural network accelerator with a systolic array structure.

According to an example embodiment, a neural network accelerator includes a memory configured to store a plurality of feature data including first feature data and second feature data and a plurality of kernel data including first kernel data and second kernel data, a first processing element configured to perform an operation based on the first feature data and the first kernel data and output the first feature data, a selection circuit configured to select one of the first feature data output from the first processing element and the second feature data output from the memory, based on a control signal, and output the selected feature data, a second processing element configured to perform an operation based on the selected feature data and one of the first kernel data and the second kernel data, and a controller configured to generate the control signal, based on a neural network characteristic associated with the plurality of feature data and the plurality of kernel data.

In an example embodiment, when the plurality of feature data are represented as a first matrix and the plurality of kernel data are represented as a second matrix, the neural network characteristic may include size information of the first matrix and size information of the second matrix.

In an example embodiment, when the first feature data are selected from the selection circuit, the second processing element may be configured to perform an operation based on the first feature data and the second kernel data.

In an example embodiment, when the second feature data are selected from the selection circuit, the second processing element may be configured to perform an operation based on the second feature data and one of the first kernel data and the second kernel data.

In an example embodiment, the memory may be positioned between the first processing element and the second processing element.

In an example embodiment, a first operation result generated by the first processing element and a second operation result generated by the second processing element may be stored in the memory.

In an example embodiment, the first processing element and the second processing element may form a systolic array structure.

According to an example embodiment, a neural network accelerator includes a memory configured to store a plurality of input data including first input data and second input data, a processing element array including a first processing element configured to perform an operation based on the first input data and a second processing element configured to perform an operation based on a selected one of the first input data output from the first processing element and the second input data output from the memory, and a controller configured to select input data to be operated in the second processing element, based on a neural network characteristic associated with the plurality of input data.

In an example embodiment, the neural network characteristic may include matrix size information that is made from the plurality of input data.

In an example embodiment, the first input data may include first feature data, and the second input data may include second feature data.

In an example embodiment, the first processing element may perform an operation based on the first feature data and kernel data transferred to the first processing element, and the second processing element may perform an operation based on one of the first feature data and the second feature data, and kernel data transferred to the second processing element.

In an example embodiment, the neural network accelerator may further include a selection circuit configured to select one of the first input data output from the first processing element and the second input data output from the memory, based on a control signal from the controller, and provide the second processing element with the selected input data.

In an example embodiment, the processing element array may include a first sub-array including the first processing element, and a second sub-array including the second processing element.

In an example embodiment, the selection circuit may be positioned on a data path between the first sub-array and the second sub-array.

In an example embodiment, the processing element array may form a systolic array structure.

### BRIEF DESCRIPTION OF THE FIGURES

FIG. 1 is a block diagram of a neural network accelerator according to an example embodiment of the inventive concepts.

FIG. 2 is a block diagram illustrating For example one example of a neural network accelerator of FIG. 1.

FIG. 3 is a block diagram illustrating For example another example of a neural network accelerator of FIG. 1.

FIG. 4 is a diagram illustrating an implementation example of a neural network accelerator according to an example embodiment of the inventive concepts.

FIG. 5A is a diagram illustrating one example of an input feature map and kernel data that are processed by a neural network accelerator of FIG. 4.

FIG. 5B is a diagram illustrating a transform matrix for a convolution operation of an input feature map and kernel data of FIG. 5A.

FIG. 5C is a diagram illustrating an example in which a neural network accelerator of FIG. 4 performs multiplication of a plurality of feature data and a plurality of kernel data of FIG. 5B.

FIG. 6A is a diagram illustrating another example of an input feature map and kernel data processed by the neural network accelerator of FIG. 4.

FIG. 6B is a diagram illustrating a transform matrix for a convolution operation of an input feature map and kernel data of FIG. 6A.

FIG. 6C is a diagram illustrating an example in which a neural network accelerator of FIG. 4 performs multiplication of a plurality of feature data and a plurality of kernel data of FIG. 6B.

FIG. 7A is a diagram illustrating another example of an input feature map and kernel data processed by a neural network accelerator of FIG. 4.

FIG. 7B is a diagram illustrating a transform matrix for a convolution operation of an input feature map and kernel data of FIG. 7A.

FIG. 7C is a diagram illustrating an example in which a neural network accelerator of FIG. 4 performs multiplication of a plurality of feature data and a plurality of kernel data of FIG. 7B.

### DETAILED DESCRIPTION

Embodiments of the inventive concepts will be described below in more detail with reference to the accompanying drawings. In the following descriptions, details such as detailed configurations and structures are provided merely to assist in an overall understanding of embodiments of the inventive concepts. Modifications of the embodiments described herein can be made by those skilled in the art without departing from the spirit and scope of the inventive concepts. Furthermore, descriptions of well-known functions and structures are omitted for clarity and brevity. The terms used in this specification are defined in consideration of the functions of the inventive concepts and are not limited to specific functions. Definitions of terms may be determined based on the description in the detailed description.

In the following drawings or the detailed description, modules or components may be connected to others in addition to the components illustrated in drawing or described in the detailed description. The modules or components may be directly or indirectly connected. The modules or components may be communicatively connected or may be physically connected.

Unless defined otherwise, all terms including technical and scientific terms used herein have the same meaning as can be understood by one of ordinary skill in the art to which the inventive concepts belongs. Generally, terms defined in the dictionary are interpreted to have equivalent meaning to the contextual meanings in the related art and are not to be construed as having ideal or overly formal meaning unless expressly defined in the text.

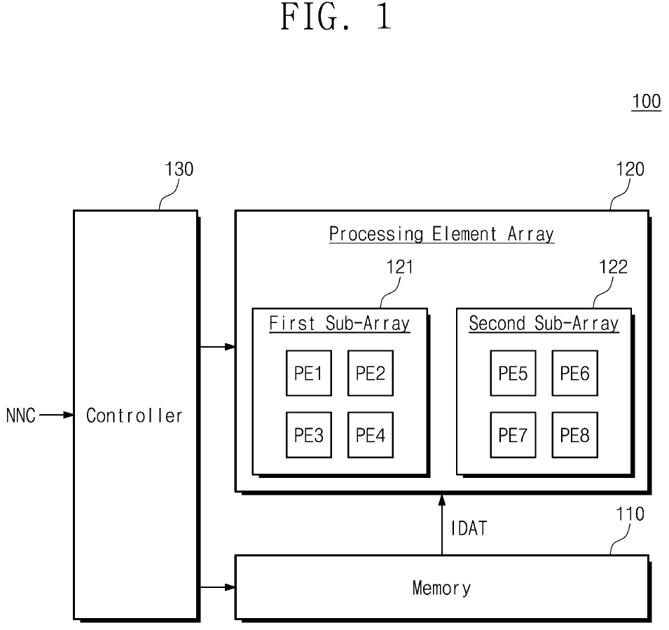

FIG. 1 is a block diagram of a neural network accelerator according to an example embodiment of the inventive concepts. A neural network accelerator 100 may process data, based on the neural network. For example, the neural network accelerator 100 may perform an operation based on an input feature map and kernel data, calculate an output feature map as a result of the operation. For example, when the neural network accelerator 100 processes image data, the input feature map may correspond to the image data, and the kernel data may be a filter (or weight) for filtering the image data. When the input feature map is filtered, the output feature map may be calculated.

Hereinafter, for convenience of explanation, it is assumed that the input feature map includes a plurality of feature data, and the input feature map is processed using a plurality of kernel data. That is, the neural network accelerator 100 may perform an operation based on the plurality of feature data and the plurality of kernel data. However, the inventive concepts are not limited thereto, and the inventive concepts may perform the operation based on one or more feature data and one or more kernel data.

The neural network accelerator 100 may be implemented as a separate chip or device, or included in a different chip or device. For example, the neural network accelerator 100 may be implemented with hardware dedicated to neural processing like a neural processing unit (NPU). Alternatively, the neural network accelerator 100 may be included in a graphics processing unit (GPU).

Referring to FIG. 1, the neural network accelerator 100 may include a memory 110, a processing element array 120, and a controller 130. The memory 110 may store input data IDAT. The memory 110 may provide the stored input data IDAT to the processing element array 120 under the control of the controller 130. The input data IDAT is data to be processed through the processing element array 120, and may include at least one of the feature data and the kernel data.

The processing element array 120 may include a plurality of processing elements PE1 to PE8. First to fourth processing elements PE1 to PE4 are included in a first sub-array 121, fifth to eighth processing elements PE5 to PE8 may be included in a second sub-array 122.

The processing element PE may perform an operation based on the input data IDAT that are provided from the memory 110. For example, the processing element PE may perform an addition operation or a multiplication operation, based on the input data IDAT. For example, the processing element PE may include at least one of an adder, a multiplier, and an accumulator.

Each the processing element PE may receive the input data IDAT and transfer the input data IDAT to the adjacent processing elements PEs. The processing element PE may transfer the input data IDAT in the row direction of the processing element array 120. For example, the first processing element PE1 may transfer the input data IDAT provided from the memory 110 to the second processing element PE2. Alternatively, the processing element PE may transfer the input data IDAT in a column direction of the processing element array 120. For example, the third processing element PE3 may transfer the input data IDAT provided from the memory 110 to the first processing element PE1. As such, the processing element PE may sequentially transfer the input data IDAT in a specific direction (e.g., at least one of the row and column directions). The processing element PE may perform the operation based on the input data IDAT that are transferred from the memory 110 or another processing element PE. That is, the processing element array 120 may have a systolic array structure.

The processing element PE of the second sub-array 122 may receive the input data IDAT from the processing element PE of the first sub-array 121, or may receive the input data IDAT from the memory 110. For example, the fifth processing element PE5 may receive the input data IDAT output from the second processing element PE2, or may receive the input data IDAT output from the memory 110. In this case, the fifth processing element PE5 may perform the operation based on the received input data IDAT and transfer the input data IDAT to the sixth processing element PE6.

When the input data IDAT output from the memory 110 is transferred to the second sub-array 122, the input data IDAT output from the first sub-array 121 may not be transferred to the second sub-array 122. When the input data IDAT output from the first sub-array 121 is transferred to the second sub-array 122, the input data IDAT output from the memory 110 may not be transferred to the second sub-array 122. A path of the input data IDAT that is transferred to the second sub-array 122 may be controlled by the controller 130. That is, a transfer path of the input data IDAT between the sub-arrays 121 and 122 may vary.

The controller 130 may control an operation of the memory 110 and the processing element array 120. The controller 130 may control the operation of the memory 110 and the processing element array 120, based on the received neural network characteristic NNC. The neural network characteristic NNC may include information associated with the input data IDAT that is a calculation target. The neural network characteristic NNC may vary depending on the input data IDAT. For example, when the input data IDAT include the feature data and kernel data, the neural network characteristic NNC may include information about a matrix size (the number of rows or columns) of the feature data and the matrix size of the kernel data.

The controller 130 may control an input data IDAT transfer path between the sub-arrays 121 and 122, based on the neural network characteristic NNC. For example, the controller 130 may control the memory 110 and the processing element array 120 such that the input data IDAT output from the first sub-array 121 is transferred to the second sub-array 122. Alternatively, the controller 130 may control the memory 110 and the processing element array 120 such that the input data IDAT output from the memory 110 is transferred to the second sub-array 122. For example, the neural network characteristics (NNC) may be provided from an external host.

As described above, according to an example embodiment of the inventive concepts, the input data IDAT transfer path between the processing elements PEs may vary based on the neural network characteristic NNC. As the data transfer path between the processing elements (PEs) is controlled based on the neural network characteristic NNC, the systolic array structure optimized for neural network characteristic NNC may be constructed. Therefore, even though the neural network characteristic NNC associated with the input data IDAT varies, because the operation may be efficiently performed by constructing the optimized systolic array structure, the utilization rate of the neural network accelerator 100 may increase.

Although the processing element array 120 in FIG. 1 includes two sub-arrays 121 and 122, and each sub-array includes four processing elements PEs, but the invention concepts are not limited thereto. For example, the processing element array 120 may include various numbers of sub-arrays and processing elements PEs. Hereinafter, for convenience of description, the operation of the neural network accelerator 100 will be described based on an example in which each sub-array includes four processing elements.

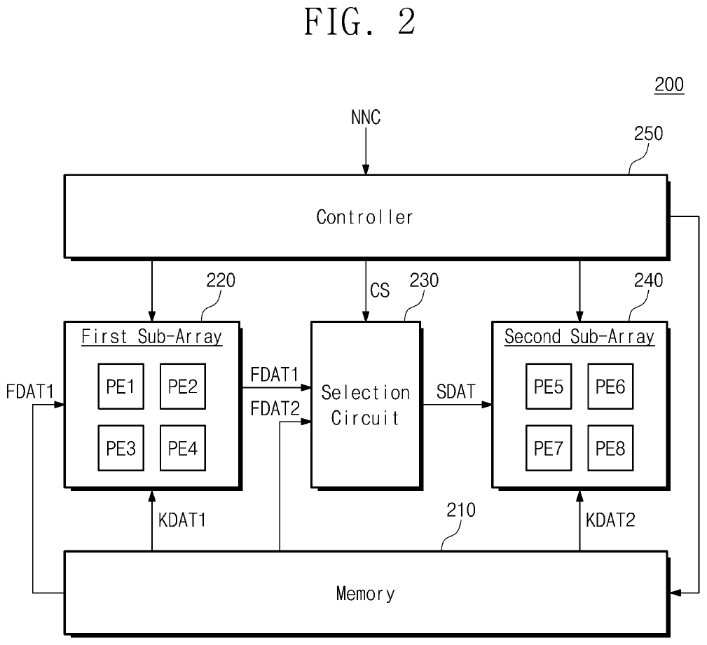

FIG. 2 is a block diagram illustrating in detail one example of a neural network accelerator of FIG. 1. Referring to FIG. 2, a neural network accelerator 200 may include a memory 210, a first sub-array 220, a selection circuit 230, a second sub-array 240, and a controller 250.

The memory 210 may store a plurality of feature data FDAT and a plurality of kernel data KDAT. That is, the memory 210 may store the feature data FDAT and the kernel data KDAT as the input data DAT of FIG. 1.The memory 210 may provide the feature data FDAT and the kernel data KDAT to the processing element PE under the control of the controller 250.For example, the memory 210 may include a volatile memory such as a Dynamic Random Access Memory (DRAM), a Synchronous DRAM (SDRAM), and/or a non-volatile memory such as a Phase-change RAM (PRAM), a Magneto-resistive RAM (MRAM), a Resistive RAM (ReRAM), a Ferro-electric RAM (FRAM).

The first sub-array 220 may include first to fourth processing elements PE1 to PE4. The first sub-array 220 may receive first feature data FDAT1 and first kernel data KDAT1 from the memory 210. The first sub-array 220 may output the first feature data FDAT1 received from the memory 210, through the processing elements PEs therein. The first feature data FDAT1 output from the first sub-array 220 may be input to the selection circuit 230. For example, the first feature data FDAT1 and the first kernel data KDAT1 may be provided to the third processing element PE3. The third processing element PE3 may perform an operation based on the first feature data FDAT1 and the first kernel data KDAT1. The third processing element PE3 may transfer the first feature data FDAT1 to the fourth processing element PE4. In addition, the third processing element PE3 may transfer the first kernel data KDAT1 to the first processing element PE1. The fourth processing element PE4 may perform an operation based on the first feature data FDAT1 transferred from the third processing element PE3, and output the first feature data FDAT1 to the selection circuit 230. In this case, the fourth processing element PE4 may perform an operation based on kernel data different from the first kernel data KDAT1.

The selection circuit 230 may select one of a data path from the first sub-array 220 and a data path from the memory 210. The selection circuit 230 may select a data path based on a control signal CS provided from the controller 250, and may output data provided to the selected data path as selection data SDAT. The output selection data SDAT may be provided to the second sub-array 240. For example, when the data path from the first sub-array 220 is selected, the selection circuit 230 selects the first feature data FDAT1 output from the first sub-array 220 as the selection data SDAT. When the data path from the memory 210 is selected, the selection circuit 230 may output the second feature data FDAT2 output from the memory 210 as the selection data SDAT.

Although the second feature data FDAT2 in FIG. 2 is output from the memory 210 to the selection circuit 230, but the inventive concepts are not limited thereto. For example, when a data path from the first sub-array 220 is selected, the memory 210 may not output any data to the selection circuit 230.That is, the memory 210 may output the second feature data FDAT2 to the selection circuit 230 only when a data path from the memory 210 is selected.

The second sub-array 240 may include fifth to eighth processing elements PE5 to PE8. The second sub-array 240 may receive the selection data SDAT provided from the selection circuit 230 and the second kernel data KDAT2 provided from the memory 210. For example, when the first feature data FDAT1 is provided as the selection data SDAT, the seventh processing element PE7 may perform an operation based on the first feature data FDAT1 and the second kernel data KDAT2. The seventh processing element PE7 may transfer the first feature data FDAT1 to the eighth processing element PE8. The eighth processing element PE8 may perform an operation based on the transferred first feature data FDAT1. In this case, the eighth processing element PE8 may perform an operation based on kernel data different from the second kernel data KDAT2.

Although the memory 210 in FIG. 2 outputs the second kernel data KDAT2 to the second sub-array 240, but the inventive concepts are not limited thereto. For example, the memory 210 may output the first kernel data KDAT1 that are identical to the kernel data KDAT output to the first sub-array 220 to the second sub-array 240. In this case, the data path from the memory 210 may be selected such that the second feature data FDAT2 may be provided to the second sub-array 240.

The controller 250 may control operations of the memory 210, the first sub-array 220, the selection circuit 230, and the second sub-array 240. The controller 250 may generate the control signal CS to be provided to the selection circuit 230, based on the neural network characteristic NNC. For example, the controller 250 may generate the control signal CS by considering matrix sizes of the feature data FDAT and the kernel data KDAT, based on the neural network characteristic NNC. The controller 250 may generate the control signal CS such that the first feature data FDAT1 output from the first sub-array 220 is transferred to the second sub-array 240. Alternatively, the controller 250 may generate the control signal CS such that the second feature data FDAT2 output from the memory 210 is transferred to the second sub-array 240. The controller 250 may change the data path input to the second sub-array 240 for efficient operation of the feature data FDAT and the kernel data KDAT, based on the neural network characteristic NNC.

An operation result that is generated by each the processing elements PEs of the first sub-array 220 and the second sub-array 240 may be stored in the memory 210. For example, the operation result may be stored in the memory 210 after transferred in the reverse direction of the path in which the feature data FDAT or the kernel data KDAT are transferred to the processing element PE.

As illustrated in FIG. 2, the first sub-array 220 and the second sub-array 240 may be arranged in a row direction. In this case, the selection circuit 230 may be positioned between the first sub-array 220 and the second sub-array 240. However, the inventive concepts are not limited thereto.

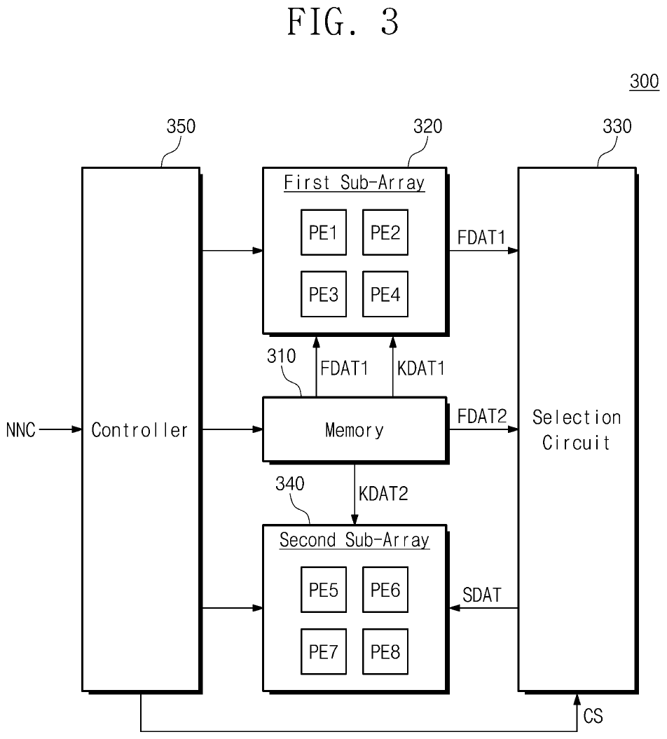

FIG. 3 is a block diagram illustrating in detail another example of a neural network accelerator of FIG. 1. Referring to FIG. 3, a neural network accelerator 300 may include a memory 310, a first sub-array 320, a selection circuit 330, a second sub-array 340, and a controller 350. Since the operations of the memory 310, the first sub-array 320, the selection circuit 330, the second sub-array 340, and the controller 350 may be substantially the same as or similar to the operations of the memory 210, the first sub-array 220, the selection circuit 230, the second sub-array 240, and the controller 250, respectively, duplicate descriptions may be omitted.

Unlike FIG. 2, the first sub-array 320 and the second sub-array 340 may be arranged in a column direction. In this case, the memory 310 may be positioned between the first sub-array 320 and the second sub-array 340. Since the memory 310 is placed between the sub-arrays 320 and 340, the memory 310 may efficiently transfer the feature data FDAT and the kernel data KDAT to the first sub-array 320 and the second sub-array 340, respectively.

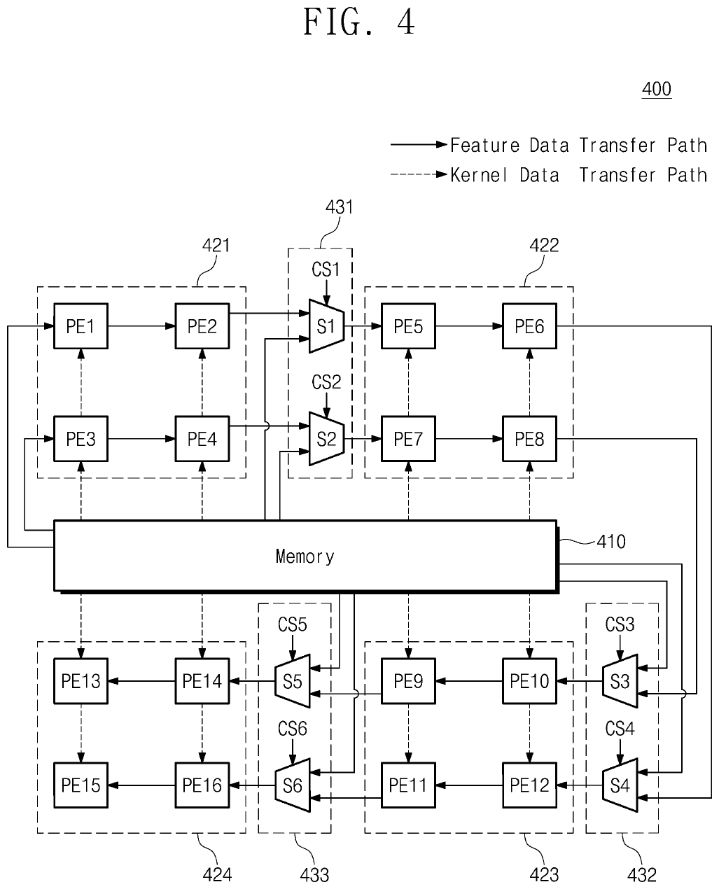

FIG. 4 is a diagram illustrating an implementation example of a neural network accelerator according to an example embodiment of the inventive concepts. Referring to FIG. 4, a neural network accelerator 400 may include a memory 410, a plurality of sub-arrays 421 to 424, and a plurality of selection circuits 431 to 433. The sub-arrays 421 to 424 may include a plurality of processing elements PE1 to PE16, and the selection circuits 431 to 433 may include a plurality of multiplexers S1 to S6. The neural network accelerator 400 may further include the controller described with reference to FIGS. 1 to 3, but for simplicity, the controller is omitted. As illustrated in FIG. 4, each the selection circuits 431 to 433 may be placed on a data path between two sub-arrays. For example, the first selection circuit 431 may be placed between the first sub-array 421 and the second sub-array 422.

The memory 410 may store the feature data and the kernel data to be processed through the neural network accelerator 400. The memory 410 may provide the feature data to the processing elements PEs along the feature data transfer path, and may provide the kernel data to the processing elements PEs along the kernel data transfer path. For example, the memory 410 may transfer one of the plurality of feature data to the first processing element PE1. The feature data transferred to the first processing element PE1 may be transferred to the second processing element PE2. The memory 410 may transfer one of the plurality of kernel data to the third processing element PE3. The kernel data transferred to the third processing element PE3 may be transferred to the first processing element PE1. The first processing element PE1 may perform an operation based on the feature data transferred from the memory 410 and the kernel data transferred from the third processing element PE3.

The multiplexers S1 to S6 may select and output one of the feature data output from the processing element PE and the feature data output from the memory 410, based on corresponding control signals CS1 to CS6. That is, the feature data transfer path between the processing elements PEs may be changed by controlling the multiplexers S1 to S6. For example, the first multiplexer S1 may output one of the feature data output from the second processing element PE2 and the feature data output from the memory 410 to the fifth processing element PE5, based on the first control signal CS1. The third multiplexer S3 may output one of the feature data output from the eighth processing element PE8 and the feature data output from the memory 410 to the tenth processing element PE10, based on a third control signal CS3.

As illustrated in FIG. 4, the neural network accelerator 400 may change the feature data transfer path between the processing elements PEs, based on the neural network characteristic NNC. Accordingly, the feature data transferred to the processing elements PEs may vary based on the neural network characteristic NNC. The neural network accelerator 400 may efficiently process the feature data.

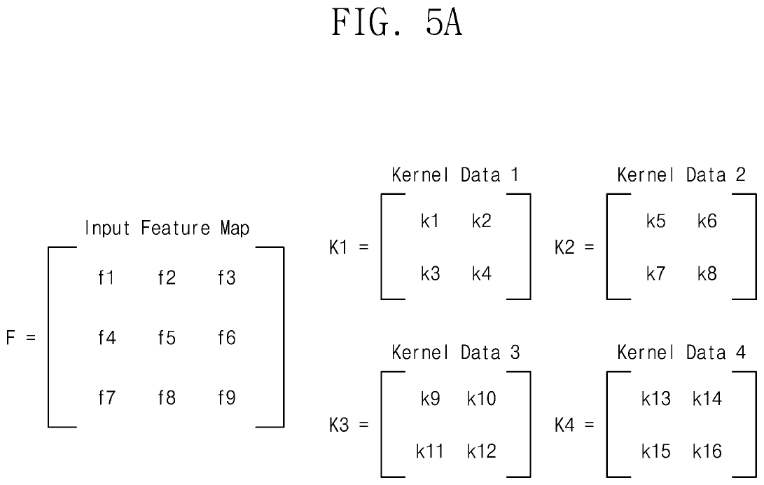

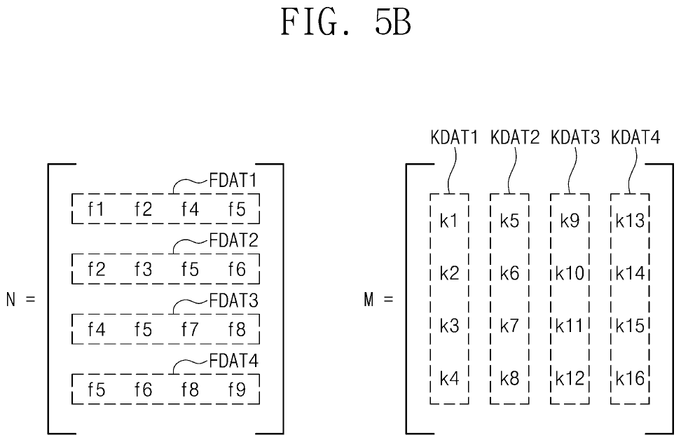

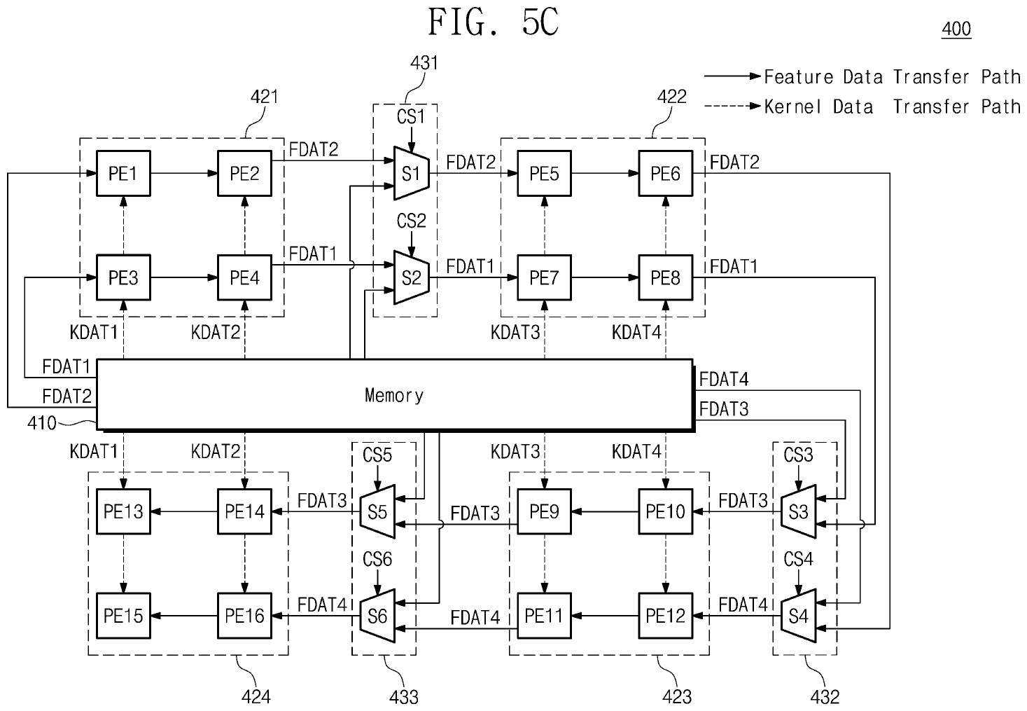

Hereinafter, an operation of the neural network accelerator 400 of FIG. 4 will be described in detail according to various neural network characteristics NNC with reference to FIGS. 5A to 7C.

FIG. 5A is a diagram illustrating one example of an input feature map and kernel data that are processed by a neural network accelerator of FIG. 4. Referring to FIG. 5A, one input feature map and four kernel data are illustrated. The one input feature map may be represented by a two-dimensional 3×3 matrix F, and the four kernel data may be represented by two-dimensional 2×2 matrices K1 to

K4. The neural network accelerator 400 of FIG. 4 may perform an operation based on the input feature map and the kernel data of FIG. 5A. For example, the neural network accelerator 400 may perform the convolution operation using the input feature map and respective kernel data. For the convolution operation, as illustrated in FIG. 5B, the input feature map may be transformed into matrix N and the kernel data may be transformed into matrix M.

FIG. 5B is a diagram illustrating a transform matrix for a convolution operation of an input feature map and kernel data of FIG. 5A. The matrix N of FIG. 5B is a transform matrix of the input feature map of FIG. 5A, and the matrix M is a transform matrix of the four kernel data of FIG. 5A. The matrix N may include the plurality of feature data FDAT1 to FDAT4 in which the input feature map of FIG. 5A is classified based on the size of the kernel data. Each the feature data may include four feature values depending on the size of the kernel data. For example, the first feature data FDAT1 may include a first feature value f1, a second feature value f2, a fourth feature value f4, and a fifth feature value f5. The matrix M may include first to fourth kernel data KDAT1 to KDAT4. The kernel data KDAT1 to KDAT4 may correspond to the 2×2 matrices K1 to K4 of FIG. 5A.

The neural network accelerator 400 may perform the convolution operation on the input feature map and the four kernel data through the multiplication of the matrix N and the matrix M. As a result of the operation, an output feature map may be calculated.

Information about the rows and columns of the matrix N and the matrix M may be provided to the neural network accelerator 400 as information about the neural network characteristic NNC. The neural network accelerator 400 may control the operation of each component, based on the provided neural network characteristic NNC such that multiplication of the matrix (N) and the matrix (M) is performed.

FIG. 5C is a diagram illustrating an example in which a neural network accelerator of FIG. 4 performs multiplication of a plurality of feature data and a plurality of kernel data of FIG. 5B. The neural network accelerator 400 may receive information in which a row size of the matrix (N) is ‘4’ (that is, four feature data FDAT1 to FDAT4) and a column size of the matrix M is ‘4’ (that is, four kernel data KDAT1 to KDAT4), as the neural network characteristic NNC. According to the neural network characteristic NNC, the operation of each component of the neural network accelerator 400 may be controlled as follows.

Referring to FIG. 5C, the first to fourth feature data FDAT1 to FDAT4 and the first to fourth kernel data KDAT1 to KDAT4 may be stored in the memory 410. The memory 410 may provide the first feature data FDAT1 and the second feature data FDAT2 to the first sub-array 421, and provide the third feature data FDAT3 and the fourth feature data FDAT4 to the second selection circuit 432. The memory 410 may provide the first kernel data KDAT1 and the second kernel data KDAT2 to the first sub-array 421 and the fourth sub-array 424, and provide the third kernel data KDAT3 and the fourth kernel data KDAT4 to the second sub-array 422 and the third sub-array 423. In this case, the memory 410 may sequentially provide a plurality of values of the feature data or the kernel data. For example, when the first feature data FDAT1 are provided to the third processing element PE3, the memory 410 may provide the first feature data FDAT1 in the order of (f1, f2, f4, f5). In addition, when the first kernel data KDAT1 are provided to the third processing element PE3, the memory 410 may provide the first kernel data KDAT1 in the order of (k1, k2, k3, k4).

The third processing element PE3 may perform an operation based on the first feature data FDAT1 and the first kernel data KDAT1. For example, the third processing element PE3 may multiply the value of the first feature data FDAT1 by the value of the first kernel data KDAT1 and accumulate a multiplication result. Accordingly, the third processing element PE3 may calculate (f1*k1+f2*k2+f4*k3+f5*k4) as an operation result.

The third processing element PE3 may transfer the first feature data FDAT1 to the fourth processing element PE4, and transfer the first kernel data KDAT1 to the first processing element PE1. Accordingly, the first processing element PE1 may perform an operation based on the second feature data FDAT2 and the first kernel data KDAT1, and the fourth processing element PE4 may perform an operation based on the first feature data FDAT1 and the second kernel data KDAT2. Likewise, the second processing element PE2 may perform an operation based on the second feature data FDAT2 and the second kernel data KDAT2.

The first selection circuit 431 may be controlled such that the first feature data FDAT1 and the second feature data FDAT2 that are output from the first sub-array 421 are transferred to the second sub-array 422. For example, the first multiplexer S1 may output the second feature data FDAT2 that are output from the second processing element PE2, to the fifth processing element PE5, based on the first control signal CS1. The second multiplexer S2 may output the first feature data FDAT1 that are output from the fourth processing element PE4, to the seventh processing element PE7, based on the second control signal CS2.

Each the fifth to eighth processing elements PE5 to PE8 may perform an operation based on the feature data and the kernel data that are transferred. That is, the fifth to eighth processing elements PE5 to PE8 may perform the operation based on the first and second feature data FDAT1 and FDAT2 and the third and fourth kernel data KDAT3 and KDAT4. The first and second feature data FDAT1 and FDAT2 that are transferred to the second sub-array 422 may be output to the second selection circuit 432.

The second selection circuit 432 may be controlled such that the third feature data FDAT3 and the fourth feature data FDAT4 that are output from the memory 410 are transferred to the third sub-array 423. When the first feature data FDAT1 is output from the third multiplexer S3, the tenth processing element PE10 may calculate an operation result overlapping with an operation result of the eighth processing element PE8. Likewise, when the second feature data FDAT2 is output from the fourth multiplexer S4, the twelfth processing element PE12 may calculate an operation result overlapping with an operation result of the sixth processing element PE6. Therefore, the third control signal CS3 and the fourth control signal CS4 may be generated such that the third feature data FDAT3 and the fourth feature data FDAT4 are output from the third multiplexer S3 and the fourth multiplexer S4, respectively. Accordingly, the third feature data FDAT3 may be transferred to the tenth processing element PE10, and the fourth feature data FDAT4 may be transferred to the twelfth processing element PE12.

Each the ninth to twelfth processing elements PE9 to PE12 may perform an operation based on the feature data and kernel data that are transferred. That is, the ninth to twelfth processing elements PE9 to PE12 may perform the operation based on the third and fourth feature data FDAT3 and FDAT4 and the third and fourth kernel data KDAT3 and KDAT4. The third and fourth feature data FDAT3 and FDAT4 that are transferred to the third sub-array 423 may be output to the third selection circuit 433.

The third selection circuit 433 may be controlled such that the third feature data FDAT3 and the fourth feature data FDAT4 that are output from the third sub-array 423 are transferred to the fourth sub-array 424. For example, the fifth multiplexer S5 may output the third feature data FDAT3 that are output from the ninth processing element PE9, based on the fifth control signal CS5. The sixth multiplexer S6 may output the fourth feature data FDAT4 that are output from the eleventh processing element PE11, based on the sixth control signal CS6.

Each the thirteenth to sixteenth processing elements PE13 to PE16 may perform an operation based on the feature data and kernel data that are transferred. That is, the thirteenth to sixteenth processing elements PE13 to PE16 may perform an operation based on the third and fourth feature data FDAT3 and FDAT4 and the first and second kernel data KDAT1 and KDAT2.

The operation result that is calculated by the operation of the processing elements PE1 to PE16 may be stored in an internal register of each the processing elements PE1 to PE16. Thereafter, the operation result may be transferred to the memory 410 through the processing element. Accordingly, the memory 410 may store an output feature map that is the result of the convolution operation of the input feature map and the kernel data of FIG. 5A.

Although the first and second kernel data KDAT1 and KDAT2 in FIG. 5C are provided to the fourth sub-array 424, and the third and fourth kernel data KDAT3 and KDAT4 are provided to the third sub-array 423, the inventive concepts are not limited thereto. For example, the memory 410 may output the first and second kernel data KDAT1 and KDAT2 to the third sub-array 423, and output the third and fourth kernel data KDAT3 and KDAT4 to the fourth sub-array 424.

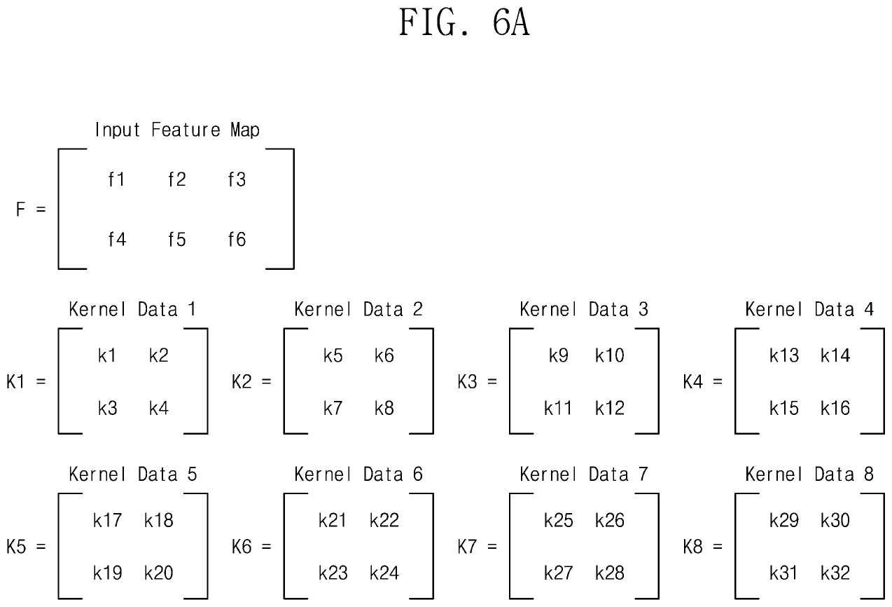

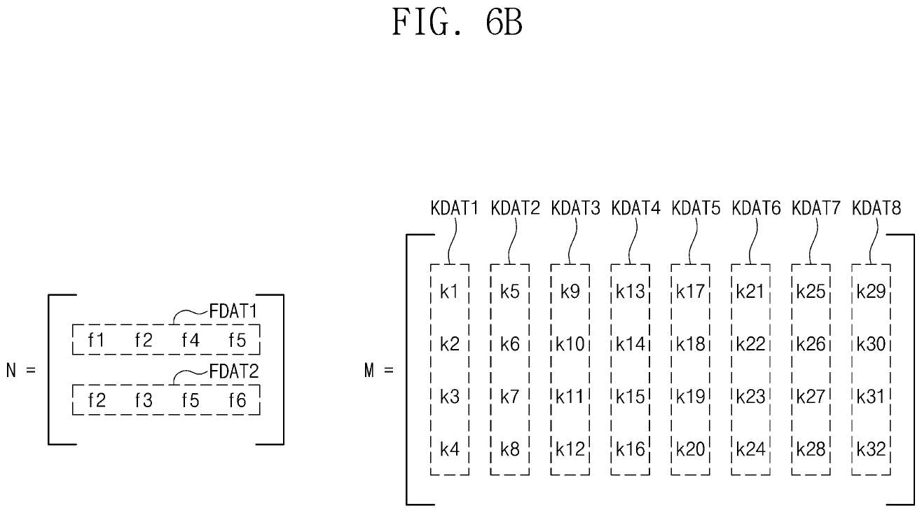

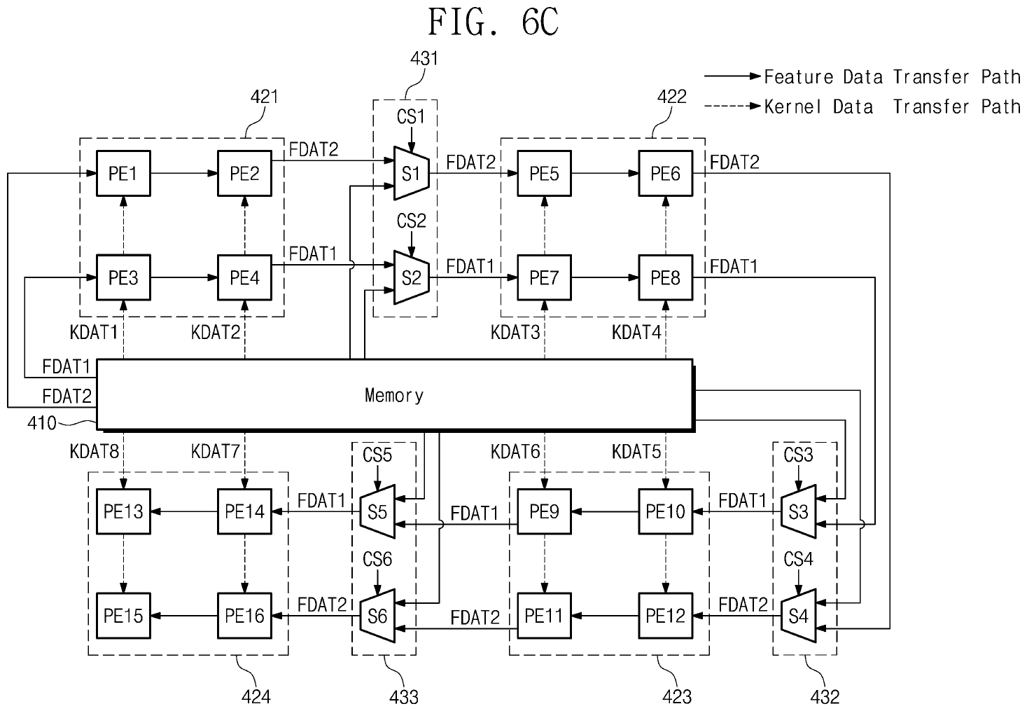

FIG. 6A is a diagram illustrating another example of an input feature map and kernel data processed by the neural network accelerator of FIG. 4. Referring to FIG. 6A, one input feature map and eight kernel data are illustrated. The one input feature map may be represented by a two-dimensional 2×3 matrix F, and the eight kernel data may be represented by the two-dimensional 2×2 matrices K1 to K8. The neural network accelerator 400 of FIG. 4 may perform an operation based on the input feature map and the kernel data of FIG. 6A. For example, the neural network accelerator 400 may perform a convolution operation using the input feature map and the respective kernel data. For the convolution operation, as illustrated in FIG. 6B, the input feature map may be transformed into the matrix N and the kernel data may be transformed to the matrix M.

FIG. 6B is a diagram illustrating a transform matrix for a convolution operation of an input feature map and kernel data of FIG. 6A. The matrix N of FIG. 6B is a transform matrix of the input feature map of FIG. 6A, and the matrix M is a transform matrix of the eight kernel data of FIG. 6A. The matrix N may include a plurality of feature data FDAT1 and FDAT2 in which the input feature map of FIG. 6A is classified based on a size of the kernel data. Each the feature data may include four feature values depending on the size of the kernel data. For example, the first feature data FDAT1 may include a first feature value f1, a second feature value f2, a fourth feature value f4, and a fifth feature value f5. The matrix M may include the first to eighth kernel data KDAT1 to KDAT8. The kernel data KDAT1 to KDAT8 may correspond to the 2×2 matrices K1 to K8 of FIG. 6A.

The neural network accelerator 400 may perform the convolution operation on the input feature map and the eight kernel data through the multiplication of the matrix N and the matrix M. As a result of the operation, the output feature map may be calculated.

Information about the row and the column of the matrix N and the matrix M may be provided to the neural network accelerator 400 as information about the neural network characteristic NNC. The neural network accelerator 400 may control the operations of each component, based on the provided neural network characteristic NNC, to perform multiplication of the matrix N and the matrix M.

FIG. 6C is a diagram illustrating an example in which a neural network accelerator of FIG. 4 performs multiplication of a plurality of feature data and a plurality of kernel data of FIG. 6B. The neural network accelerator 400 may receive information in which a row size of the matrix N is ‘2’ (that is, the two feature data FDAT1 and FDAT2), and a column size of the matrix M is ‘8’ (that is, the eight kernel data KDAT1 to KDAT8), as the neural network characteristic NNC. Based on the neural network characteristic NNC, the operations of each component of the neural network accelerator 400 may be controlled as follows.

Referring to FIG. 6C, the first and second feature data FDAT1 and FDAT2 and the first to eighth kernel data KDAT1 to KDAT8 may be stored in the memory 410. The memory 410 may provide the first feature data FDAT1 and the second feature data FDAT2 to the first sub-array 421. The memory 410 may provide the first and second kernel data KDAT1 and KDAT2 to the first sub-array 421, provide the third and fourth kernel data KDAT3 and KDAT4 to the second sub-array 422, provide the fifth and sixth kernel data KDAT5 and KDAT6 to the third sub-array 423, and provide the seventh and eighth kernel data KDAT7 and KDAT8 to the fourth sub-array 424.

The first to third selection circuits 431 to 433 may be controlled such that the first and second feature data FDAT1 and FDAT2 are transferred from the first sub-array 421 to the fourth sub-array 424. Accordingly, the first sub-array 421 may perform an operation based on the first and second feature data FDAT1 and FDAT2 and the first and second kernel data KDAT1 and KDAT2. The second sub-array 422 may perform an operation based on the first and second feature data FDAT1 and FDAT2 and the third and fourth kernel data KDAT3 and KDAT4. The third sub-array 423 may perform an operation based on the first and second feature data FDAT1 and FDAT2 and the fifth and sixth kernel data KDAT5 and KDAT6. The fourth sub-array 424 may perform an operation based on the first and second feature data FDAT1 and FDAT2 and the seventh and eighth kernel data KDAT7 and KDAT8. As such, a multiplication operation on the matrix N and the matrix M of FIG. 6B may be performed through the first to sixteenth processing elements PE1 to PE16. The operation result generated by the operation of the processing elements PE1 to PE16 may be stored in the memory 410.

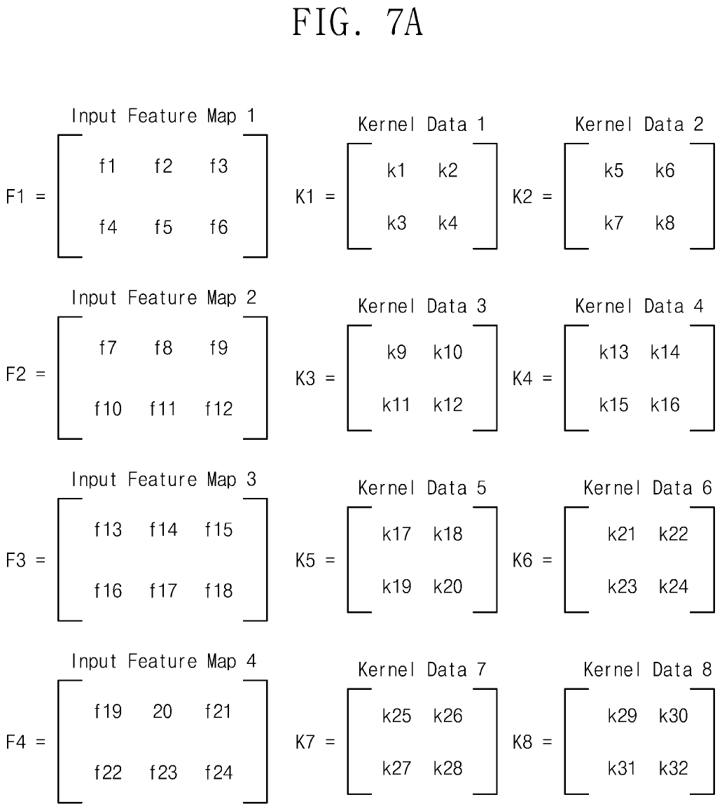

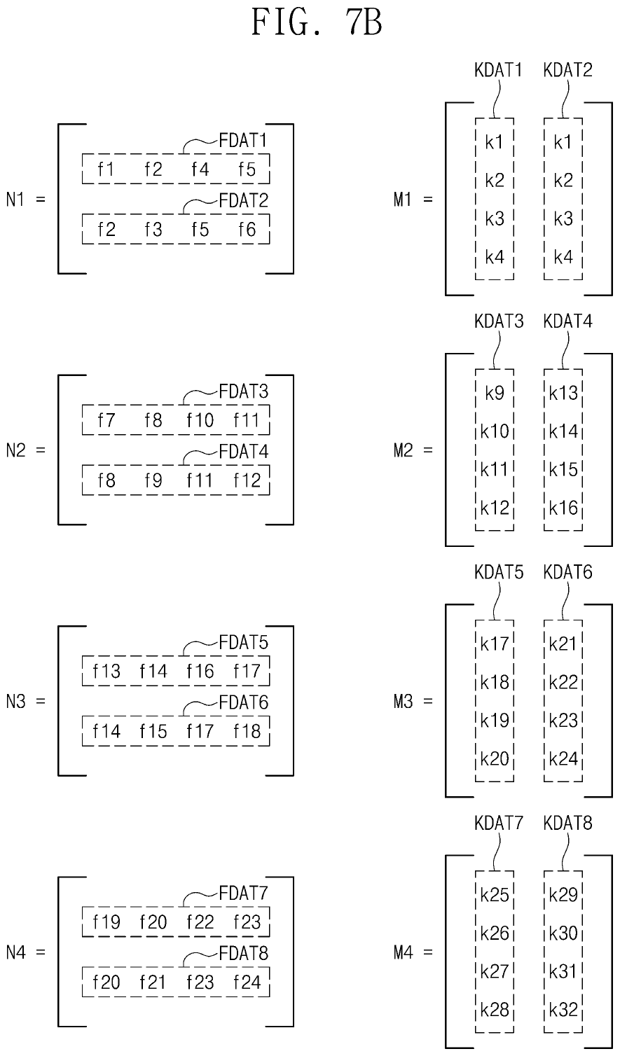

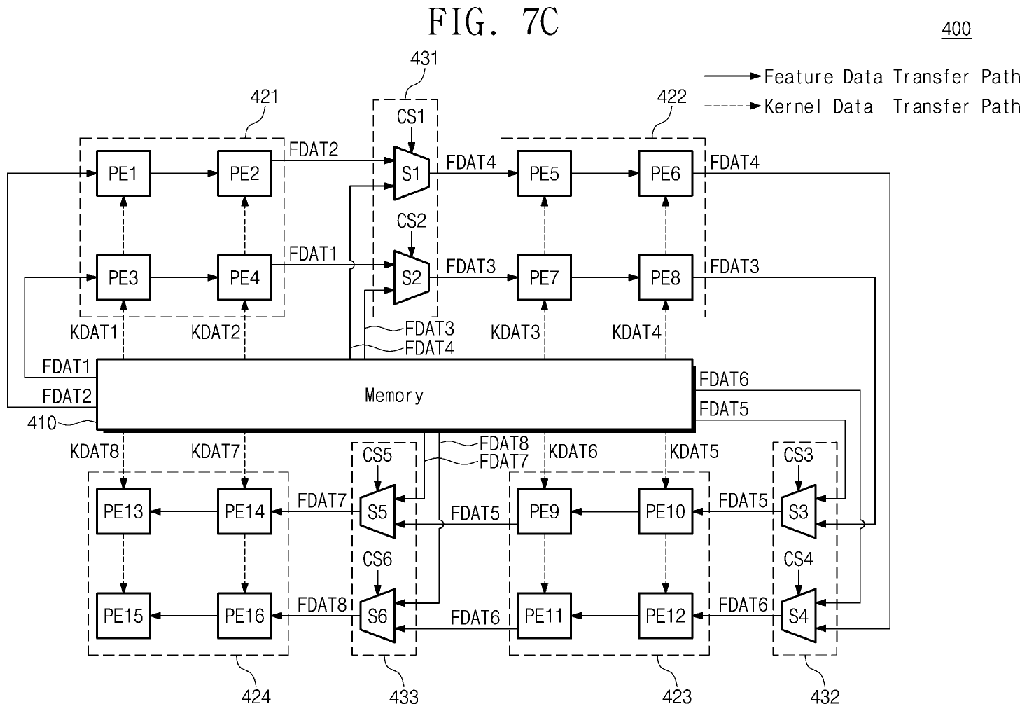

FIG. 7A is a diagram illustrating another example of an input feature map and kernel data processed by a neural network accelerator of FIG. 4. Referring to FIG. 7A, four input feature maps and eight kernel data are illustrated. The four input feature maps may be represented by two-dimensional 2×3 matrices F1 to F4, and the eight kernel data may be represented by two-dimensional 2×2 matrices K1 to K8. Each the input feature maps may correspond to two kernel data. For example, the input feature map F1 may correspond to the kernel data K1 and the kernel data K2.

The neural network accelerator 400 of FIG. 4 may perform an operation based on the input feature map and the kernel data of FIG. 7A. For example, the neural network accelerator 400 may perform the convolution operation using each input feature map and corresponding two kernel data. For the convolution operation, as illustrated in FIG. 7B, the four input feature maps may be transformed into four matrices N1 to N4 and the eight kernel data may be transformed into four matrices M1 to M4.

FIG. 7B is a diagram illustrating a transform matrix for a convolution operation of an input feature map and kernel data of FIG. 7A. The matrices N1 to N4 of FIG. 7B are transform matrices of the matrixes F1 to F4 of FIG. 7A, and the matrices M1 to M4 are transform matrices of the matrices K1 to K8 of FIG. 7A. The matrices N1 to N4 may include a plurality of feature data FDAT1 to FDAT8 in which the input feature maps of FIG. 7A are classified based on a size of the kernel data. For example, the matrix N1 may include the first and second feature data FDAT1 to FDAT2. Each the feature data may include four feature values depending on the size of the kernel data. For example, the first kernel data FDAT1 may include a first feature value f1, a second feature value f2, a fourth feature value f4, and a fifth feature value f5. The matrices M1 to M4 may include the first to eighth kernel data KDAT1 to KDAT8. For example, the matrix M1 may include the first and second kernel data KDAT1 to KDAT2. The kernel data KDAT1 to KDAT8 may correspond to the 2×2 matrices K1 to K8 of FIG. 7A.

The neural network accelerator 400 may perform the convolution operation on the input feature map and the kernel data through matrix multiplication, based on the matrices N1 to N4 and the matrices M1 to M4. For example, the convolution operation on the input feature map F1 and the kernel data K1 and K2 of FIG. 7A may be performed by multiplying the matrix N1 and the matrix M1. As a result of the operation, an output feature map may be calculated.

Information about the rows and columns of the matrices N1 to N4 and the matrices M1 to M4 may be provided to the neural network accelerator 400, as information about the neural network characteristic NNC. The neural network accelerator 400 may control the operations of each component, based on the provided neural network characteristic NNC to perform multiplication of the matrices N1 to N4 and the matrices M1 to M4.

FIG. 7C illustrates an example in which a neural network accelerator of FIG. 4 performs multiplication of a plurality of feature data and a plurality of kernel data of FIG. 7B. The neural network accelerator 400 may receive information in which the row size of each the matrices N1 to N4 is ‘2’ (i.e., two feature data), and the column size of each the matrices M1 to M4 is ‘2’ (i.e., two kernel data), as the neural network characteristic NNC. Based on the neural network characteristic NNC, the operations of each component of the neural network accelerator 400 may be controlled as follows.

Referring to FIG. 7C, the first to eighth feature data FDAT1 to FDAT8 and the first to eighth kernel data KDAT1 to KDAT8 may be stored in the memory 410. The memory 410 may provide the first feature data FDAT1 and the second feature data FDAT2 to the first sub-array 421. The memory 410 may provide the third feature data FDAT3 and the fourth feature data FDAT4 to the first selection circuit 431. The memory 410 may provide the fifth feature data FDAT5 and the sixth feature data FDAT6 to the second selection circuit 432. The memory 410 may provide the seventh feature data FDAT7 and the eighth feature data FDAT8 to the third selection circuit 433. The memory 410 may provide the first and second kernel data KDAT1 and KDAT2 to the first sub-array 421, provide the third and fourth kernel data KDAT3 and KDAT4 to the second sub-array 422, provide the fifth and sixth kernel data KDAT5 and KDAT6 to the third sub-array 423, and provide the seventh and eighth kernel data KDAT7 and KDAT8 to the fourth sub-array 424.

The first sub-array 421 may perform an operation based on the first and second feature data FDAT1 and FDAT2 and the first and second kernel data KDAT1 and KDAT2. The first sub-array 421 may output the first and second feature data FDAT1 and FDAT2 to the first selection circuit 431.The first selection circuit 431 may be controlled such that the third and fourth feature data FDAT3 and FDAT4 that are output from the memory 410 are transferred to the second sub-array 422.

The second sub-array 422 may perform an operation based on the third and fourth feature data FDAT3 and FDAT4 and the third and fourth kernel data KDAT3 and KDAT4. The second sub-array 422 may output the third and fourth feature data FDAT3 and FDAT4 to the second selection circuit 432. The second selection circuit 432 may be controlled such that the fifth and sixth feature data FDAT5 and FDAT6 that are output from the memory 410 are transferred to the third sub-array 423.

The third sub-array 423 may perform an operation based on the fifth and sixth feature data FDAT5 and FDAT6 and the fifth and sixth kernel data KDAT5 and KDAT6. The third sub-array 423 may output the fifth and sixth feature data FDAT5 and FDAT6 to the third selection circuit 433. The third selection circuit 433 may be controlled such that the seventh and eighth feature data FDAT7 and FDAT8 that are output from the memory 410 are transferred to the fourth sub-array 424. The fourth sub-array 424 may perform an operation based on the seventh and eighth feature data FDAT7 and FDAT8 and the seventh and eighth kernel data KDAT7 and KDAT8.

Accordingly, a multiplication operation on the matrices N1 to N4 and the matrices M1 to M4 of FIG. 7B may be performed through the first to sixteenth processing elements PE1 to PE16. In this case, the matrix operation may be performed in parallel in each the sub-arrays. For example, the multiplication of the matrix N1 and the matrix M1 by the first sub-array 421 and the multiplication of the matrix N2 and the matrix M2 by the second sub-array 422 may be performed in parallel. The operation result generated by the operation of the processing elements PE1 to PE16 may be stored in the memory 410.

As described above, the neural network accelerator 400 may change the data transfer path between the processing elements, based on the neural network characteristic NNC associated with the feature data and the kernel data. That is, the neural network accelerator 400 may control each component, based on the neural network characteristic NNC, and perform a convolution operation on the feature data and the kernel data. Accordingly, the utilization rate of the neural network accelerator 400 may be improved.

According to embodiments of the inventive concepts, the neural network accelerator with the systolic array structure may improve the utilization rate of the neural network accelerator at low cost by adjusting a data transfer path between the processing elements, based on the neural network characteristics.

The contents described above are specific embodiments for implementing the inventive concepts. The inventive concepts may include not only the embodiments described above but also embodiments in which a design is simply or easily capable of being changed. In addition, the inventive concepts may also include technologies easily changed to be implemented using embodiments. Therefore, the scope of the inventive concepts is not limited to the described embodiments but should be defined by the claims and their equivalents.

What is claimed is:

1. A neural network accelerator comprising:
a memory configured to store a plurality of feature data including first feature data and second feature data and a plurality of kernel data including first kernel data and second kernel data;
a first processing element configured to perform an operation based on the first feature data and the first kernel data and output the first feature data;
a selection circuit configured to select one of the first feature data output from the first processing element and the second feature data output from the memory, based on a control signal, and output the selected feature data;
a second processing element configured to perform an operation based on the selected feature data and one of the first kernel data and the second kernel data; and
a controller configured to generate the control signal, based on a neural network characteristic associated with the plurality of feature data and the plurality of kernel data.

2. The neural network accelerator of claim 1, wherein, when the plurality of feature data are represented as a first matrix and the plurality of kernel data are represented as a second matrix, the neural network characteristic includes size information of the first matrix and size information of the second matrix.

3. The neural network accelerator of claim 1, wherein, when the first feature data are selected from the selection circuit, the second processing element is configured to perform an operation based on the first feature data and the second kernel data.

4. The neural network accelerator of claim 1, wherein, when the second feature data are selected from the selection circuit, the second processing element is configured to perform an operation based on the second feature data and one of the first kernel data and the second kernel data.

5. The neural network accelerator of claim 1, wherein the memory is positioned between the first processing element and the second processing element.

6. The neural network accelerator of claim 1, wherein a first operation result generated by the first processing element and a second operation result generated by the second processing element are stored in the memory.

7. The neural network accelerator of claim 1, wherein the first processing element and the second processing element form a systolic array structure.

8. A neural network accelerator comprising:
a memory configured to store a plurality of input data including first input data and second input data;
a processing element array including a first processing element configured to perform an operation based on the first input data, and a second processing element configured to perform an operation based on a selected one of the first input data output from the first processing element and the second input data output from the memory; and
a controller configured to select input data to be operated in the second processing element, based on a neural network characteristic associated with the plurality of input data.

9. The neural network accelerator of claim 8, wherein the neural network characteristic includes matrix size information that is made from the plurality of input data.

10. The neural network accelerator of claim 8, wherein the first input data includes first feature data, and the second input data includes second feature data.

11. The neural network accelerator of claim 10, wherein the first processing element performs an operation based on the first feature data and kernel data transferred to the first processing element, and the second processing element performs an operation based on one of the first feature data and the second feature data, and kernel data transferred to the second processing element.

12. The neural network accelerator of claim 8, further comprising:
a selection circuit configured to select one of the first input data output from the first processing element and the second input data output from the memory, based on a control signal from the controller, and provide the second processing element with the selected input data.

13. The neural network accelerator of claim 12, the processing element array includes:
a first sub-array including the first processing element; and
a second sub-array including the second processing element.

14. The neural network accelerator of claim 13, the selection circuit is positioned on a data path between the first sub-array and the second sub-array.

15. The neural network accelerator of claim 8, the processing element array forms a systolic array structure.
